(19) United States
(12) Patent Application Publication
(10) Pub. No.: US 2009/0291316 A1
(43) Pub. Date: Nov. 26, 2009

(54) TWO-COLORED SHAPED CERAMIC PARTS

(76) Inventors: Thomas RAUCH, Innsbruck (AT); Hannes Hatzl, Rum (AT); Michael Biebl, Innsbruck (AT)

Correspondence Address: WENDEROTH, LIND & PONACK, L.L.P., 1030 15th Street, N.W.,, Suite 400 East, Washington, DC, 20005-1503, US

(21) Appl. No.: 12/468,213

(22) Filed: May 19, 2009

(30) Foreign Application Priority Data
May 21, 2008 (AT) A 811/2008

(51) Int. Cl. C04B 35/628; A44C 27/00; B29B 9/00; C04B 35/64

(52) U.S. Cl. 428/542.2; 264/73; 264/75; 264/603

(57) ABSTRACT

A process for the production of at least two-colored shaped ceramic parts from a granular ceramic raw material having a first of the at least two colors, wherein the second of the at least two colors is added as a colored pigment or a colored pigment substance and the surface of the granular ceramic raw material is at least partially coated, wherein the coated granular ceramic raw material is then pressed into a solid form.

The invention concerns a process for the production of at least two-colored shaped ceramic parts from a granular ceramic raw material having a first of the at least two colors.

DE 34 45 189 C2 discloses a process for the production of a semi-precious stone-like hard material which for final processing can be cut, cleaved, ground or polished. In that procedure a filler present in a doughy consistency is divided up, coated with an additional pigment and compressed again. Depending on the respective choice of the applied layer, the result is a corresponding decorative effect. A disadvantage with the specified process is that the base material for the coating must be of a doughy consistency and therefore pressing in the dry condition is not possible, so that this process is difficult to automate. Furthermore a binding agent which under some circumstances is of a complex structure has to be added to the filler.

A further process for the production of multi-colored shaped ceramic parts is described in EP 0 700 796 B1. In the process disclosed therein two granular materials which contain ceramic powder and binding agents from the group of the polyacetals, wherein the binding agents in one of the granular materials have a proportion of the granular material of between 30 and 60% by volume, as well as coloring particles, are shaped, the binding agents are removed and sintering is effected to produce a shaped ceramic part with particles having a different coloring effect, in a different level of concentration. Pressing the variously colored granulated materials produces a multi-colored shaped ceramic part with a spot-shaped pattern. In addition, besides high costs, the high proportions of binding agents have the disadvantage of a complicated and expensive operation for the removal thereof.

The object of the invention is to provide a process which avoids the above-specified disadvantages and permits simpler production of an at least two-colored shaped ceramic part, wherein the second of the at least two colors occurs in a band-like structure on the finished shaped ceramic part. That band-like structure can be of regular or irregular shape and size, with fluid or sharply defined color boundaries.

In the process according to the invention that is attained in that the second of the at least two colors is added as a natural and/or synthetic colored pigment and additionally or alternatively a colored pigment substance and the surface of the granular ceramic raw material is at least partially coated, wherein the coated granular ceramic raw material is then pressed into a solid form. Due to the addition of the coloring agent which is in the form of a colored pigment or colored pigment substance, it can be at least partially distributed on the surface of the granules of the granular ceramic raw material and can remain clinging thereto, whereby the coatings according to the invention on the granular ceramic raw material and subsequently the strip-shaped colored regions of the shaped ceramic parts are produced. In that case the surface of the granules of the granular ceramic raw material can be only partially coated or also only parts of the granular ceramic raw material can be coated and the coating and thus also the band-like structure can be irregular. Preferably in that respect more than 50 percent of the surface of the granular ceramic raw material is coated. After the pressing operation, such a coating on the granular material produced in various per se known manners affords an at least two-colored shaped ceramic part, wherein the second color is in the form of a band-like structure which can be irregular. The colored regions are shown off to correspondingly greater advantage if the shaped ceramic part is processed for example by grinding and/or cutting and polishing to produce a decorative gem. In that case the color boundaries can be sharply defined so that it is possible to provide for example a marbled surface structure.

The colored pigments which are contained pure or in a colored pigment substance can be commercially available ceramic colored pigments as are offered by various manufacturers. Frequently these involve thermally and chemically stable mixed oxides such as for example praseodymium yellow CAS 68187-15-5 or black CAS 68555-06-6. Coloring substances which can contain elements from the group of transition metals or lanthanides can also be used as a colored pigment or colored pigment substance in pulpy or fluid form. The excess colored pigments or the excess colored pigment substance is sieved off.

In a particularly preferred embodiment of the invention the colored pigment substance represents a fluid or pulpy substance which can coat the granular ceramic raw material, for example a colored pigment-water suspension. That permits simple application of the coloring agents, for example by spraying, and the coloring agents can already partially coat the surface of the granular ceramic raw material in the application procedure. Flowing instead of sharp color patterns can be made possible by using a fluid or pulpy colored pigment substance.

In another embodiment of the invention the surface of the granular ceramic raw material is partially coated with a colored pigment substance in powder form. In that case the colored pigment substance in powder form has a proportion of the ceramic raw material and represents a fine powder which is not capable of trickle flow. That proportion is preferably less than 65% by weight, for example about 50% by weight. That proportion of ceramic basic material provides that a possibly subsequent sintering operation is facilitated and porosity is reduced.

In a particularly preferred embodiment of the invention the surface of the granular ceramic raw material is partially coated by the granular ceramic raw material being mixed with the colored pigment or the colored pigment substance. In that way, depending on the respective nature and duration of the mixing operation, the coating on the grains can be produced in irregular fashion and thus colored regions of randomly distributed shape and size can occur on the shaped ceramic parts according to the invention.

The decorative effect, afforded by the band-like structure, of the at least two-colored shaped ceramic part depends originally on the shape, size and color of the granular material. The granular material itself comprises pourable grains of the ceramic raw material, wherein the grains can in principle be of any shape and size. In a preferred embodiment of the invention the granular ceramic raw material comprises grains of a grain size of less than 5 mm, preferably less than 3 mm. In that respect, in an embodiment of the invention, the ceramic raw material which is in the form of powder or fine initial granular material and to which a natural and/or synthetic colored pigment can be added is pressed to form parts of a predetermined shape. Preferably these involve spherical and/or parallelepipedic shapes. Commercially available pressing machines can be used for that purpose, as are known for example from the production of tablets. Such a granulation process produces a granular material of uniform, predetermined shape. It is however also possible to provide that the ceramic raw material is pressed to afford a granular material by a roller press, that is to say two oppositely rotating rollers arranged at a small spacing.

In a further embodiment of the invention the ceramic raw material which is in the form of powder or very fine initial granular material is pressed into shells. Those pressed shells are then broken up, whereupon then the material grain can be sieved off. Such a granulation process results in edged granular materials.

It can also be provided that a binding agent is added to the ceramic raw material for the granulation operation. This can involve water, in which case the proportion of the binding agent can be between 5% and 25%, preferably between 10% and 20%. The resulting lumps which cling together are mechanically broken up by mixing tools and/or blades. The equilibrium which occurs between lump formation and lump break-up provides that the drying operation results in a granular material with round edges on the grains and grains of relatively equal size.

In another embodiment of the invention the ceramic raw material in the form of dry powder or fine initial granular material is mechanically moved and in that situation simultaneously sprayed with liquid until lumps of a desired size occur. As a result relatively round granular materials are produced after a drying operation.

In another embodiment of the invention a binding agent, for example water, is added to the ceramic raw material, in which case the proportion of the binding agent can be between 5% and 25%, preferably between 15% and 20%. The resulting moist material is extruded through a sieve, whereupon, after drying, depending on the respective sieve used, different shapes of granular material are produced. Those shapes can be cylindrical, quadrangular, cuboidal, stellate or the like. It can also be provided that the material extruded through the sieve is rounded. In that case, the result is well-rounded granular materials.

In a particular embodiment of the invention the ceramic raw material, before the granular material to be coated is produced, is in the form of powder or fine initial granular material, preferably comprising minerals of grain sizes of less than 100 μm. The ceramic raw material itself, depending on respective availability, comprises a mixture of clays, feldspars, feldspar representatives, feldspar sands and quartz. A typical mixture can in that case comprise for example about 40% clay, 8% kaolin, 16% feldspar and 35% feldspar sand so that the result is a chemical composition in coarse form of about 70% SiO₂, 18.5% Al₂O₃, 4.5% Na₂O, 1.8% K₂O, 0.5% CaO, 0.3% MgO, less than 1% Fe₂O₃, less than 1% TiO₂ and about 3% product moisture. It can also be provided that the ceramic raw material is selected generally from a region of a triangular diagram with SiO₂, A1₂O₃ and alkali metal oxides, which describes more than 90% by weight of the mass of the ceramic raw material. It may further be advantageous to add phosphates, for example in the form of bone ash, to the argillaceous basic raw material mass.

In an embodiment of the invention the ceramic raw material itself can be of one or more colors and the first of the at least two colors of the shaped ceramic part can in that case be one of the initial colors of the ceramic raw material which is to be granulated and coated with the second of the at least two colors. It may also be the case however that the first of the at least two colors of the shaped ceramic part is added to the ceramic raw material before it is granulated, in the form of natural and/or synthetic colored pigment or colored pigment substance, and mixed with the ceramic raw material, preferably if it is in the form of powder or fine initial granular material.

The respective granulating method used, which can include one of the above-mentioned methods, determines the shape of the band-like structure and thus the effects which are afforded overall, starting from the granular material, by virtue of the at least partial coating and the pressing procedure. For example the shape of the effects, that is to say the band-like structure, can be substantially angular, irregular, round, regular or the like.

In another embodiment of the invention the granular ceramic raw material is moved, for example in a preferably inclinedly disposed drum, and sprayed with a fluid colored pigment substance, for example in the form of a colored pigment-water suspension, whereby the movement of the drum provides that the colored pigment substance and the granular ceramic raw material are mixed and the colored pigment substance is deposited at the surface of the granular ceramic raw material and it can be at least partially coated. In a preferred embodiment in that respect more than 50% of the surface of the granular ceramic raw material is coated.

It can also be advantageous for the coating operation to be performed at least twice, with differently colored pigments or colored pigment substances in each case, and additionally or alternatively with colored pigments or colored pigment substances of substantially the same color but in a differing concentration to produce widely varying decorative effects. It can also be provided that preferably after a coating operation, the granulation process is repeated in accordance with one of the aforementioned methods.

In an embodiment of the invention it can further be provided that prior to the actual granular ceramic raw material pressing operation, parts of the granular ceramic raw material are pressed to produce special shapes and pre-sintered so that those shapes are substantially retained during the actual pressing operation. Those special shapes can be spheres or parallelepipeds but may also include special motifs such as hearts or the like. That sintering operation can take place for example at a temperature of less than 1000° C.

After the ceramic raw material has been granulated and at least partially coated the ceramic raw material is pressed, thereby producing a relatively porous body. During that pressing operation the granulated and at least partially coated ceramic raw material is subjected to pressures of preferably between 100 and 500 bars. It can also be provided that operation is effected using pressures of several thousand bars. In an embodiment that pressing operation provides bodies of dimensions of preferably between 3 mm and 100 mm.

A further embodiment of the invention provides that prior to the pressing operation, still a further granular ceramic raw material is added to the at least partially coated granular ceramic raw material according to the invention. In that case that further granular ceramic raw material can also be at least partially coated, in which case that coating can be produced with a process as described hereinbefore. In that respect it may be advantageous for that further granular ceramic raw material itself and in addition or alternatively the coating thereof to be of a different color from the granular ceramic raw material and/or its coating. Such an addition makes it possible to produce a shaped ceramic part with more than two colors and additionally or alternatively two differently colored band-like structures.

An embodiment of the invention provides that arranged at the pressed shaped ceramic part is a device for fixing to a carrier. That can be a hole arranged in the shaped ceramic part so that for example it can be threaded as a gem on to a chain.

In a preferred embodiment of the invention the pressed granular ceramic raw material is sintered, preferably after it has been at least partially coated, whereby large parts of the enclosed air disappear and porosity is markedly reduced. It can be provided in that respect that the pressed ceramic raw material is sintered at a temperature of between 500° C. and 1300° C., preferably at about 1200° C., for about 30 minutes.

Due to the pressing operation it can happen that the colored pigment or the colored pigment substance accumulates at the edge of the shaped ceramic part and the latter is of a single color in portion-wise manner, which is unwanted. A particularly preferred embodiment of the invention therefore provides that the shaped ceramic part according to the invention is scoured, for example by one or more shaped ceramic parts being moved in a drum. In that way the surface is abrasively treated and at least parts of the color at the surface are scoured off, whereby the colored regions of the individual grains become visible at the surface. In that respect that scouring process can be effected prior to or after a sintering operation which is possibly effected for the shaped ceramic part according to the invention.

In a preferred embodiment of the invention the pressed granular ceramic raw material is passed to a further mechanical processing operation, preferably after it has been sintered, to achieve further desired decorative effects. It can be provided in that respect that at least sub-regions of the surface are ground and additionally or alternatively polished, for example to produce a faceted surface. It can further be provided that the pressed granular ceramic raw material is cut and/or cleaved and additionally or alternatively ground and/or polished. By virtue of mechanical processing of the pressed granular ceramic raw material and the at least partial coating, the result is here varied and preferably irregular color effects with at least two colors, the second of the at least two colors occurring in a band-like structure on the shaped ceramic part. In particular the shaped ceramic part produced in that way can be a decorative gem which depending on the respective mechanical processing can be for example round or partially provided with facets or can at least in portion-wise manner have a surface in the shape of a regular or irregular polyhedron. A further embodiment of the invention can also provide that, after the pressed shaped ceramic part has been scoured and sintered, only parts of the surface of the shaped ceramic part are passed to a further mechanical treatment, for example grinding and/or polishing. That can result in varied combinations of ground and/or polished surfaces with surfaces which are left natural, wherein the surfaces left natural, by virtue of the irregular scouring process, have a certain roughness while the ground and/or polished surfaces are smooth.

Further details and advantages of the present invention will be described more fully hereinafter by means of the specific description with reference to the drawings in which:

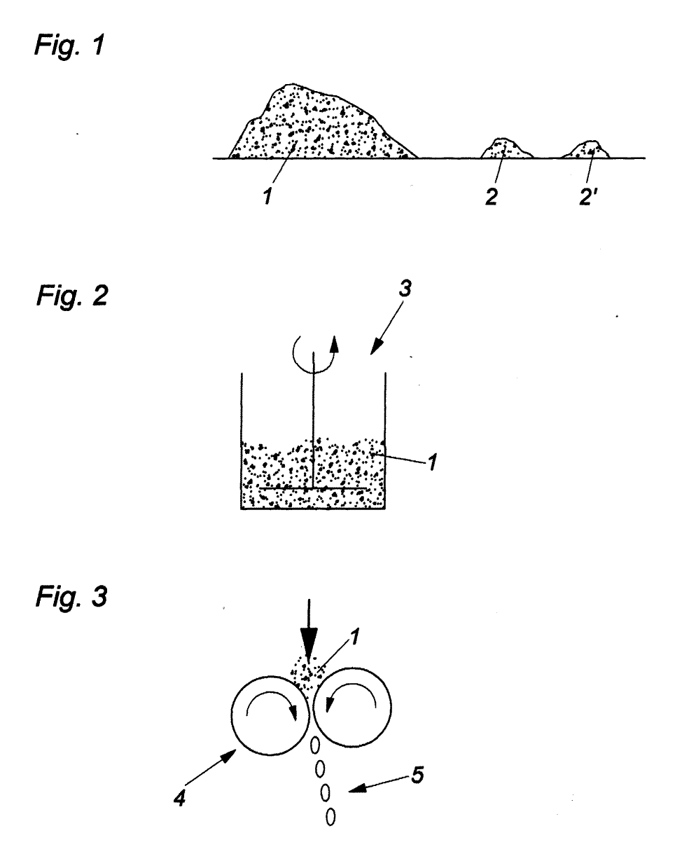

FIG. 1 shows a diagrammatic view of the starting materials of the process according to the invention,

FIG. 2 shows a diagrammatic view of a ceramic raw material mixing operation,

FIG. 3 shows a diagrammatic view of manufacture of granular ceramic raw material from ceramic raw material,

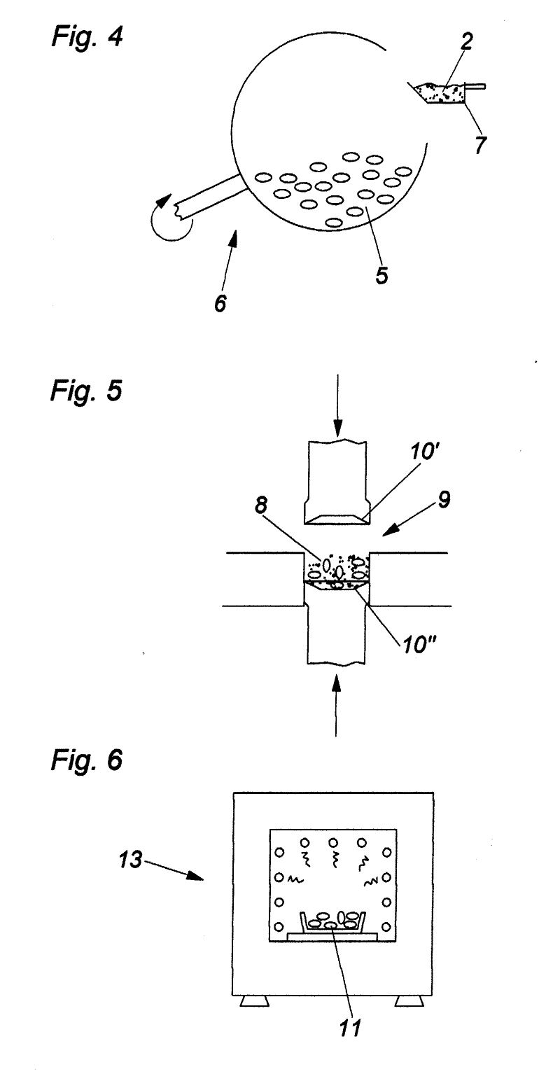

FIG. 4 shows a diagrammatic view of the addition of colored pigment substance to the granular ceramic raw material,

FIG. 5 shows a diagrammatic view of a pressing operation for at least partially coated granular ceramic raw material,

FIG. 6 shows a diagrammatic view of a sintering process for at least partially coated and pressed granular ceramic raw material,

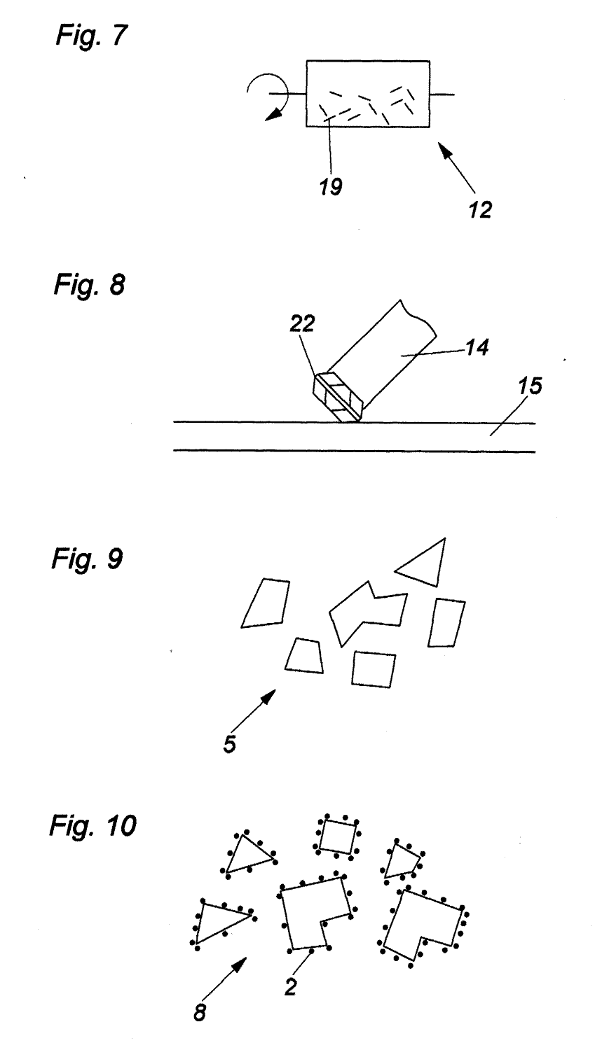

FIG. 7 shows a diagrammatic view of a scouring process for at least partially coated and pressed as well as sintered granular ceramic raw material,

FIG. 8 shows a diagrammatic view of a grinding process for at least partially coated, pressed, sintered and scoured granular ceramic raw material,

FIG. 9 shows a diagrammatic view of a granular ceramic raw material,

FIG. 10 shows a diagrammatic view of at least partially coated granular ceramic raw material,

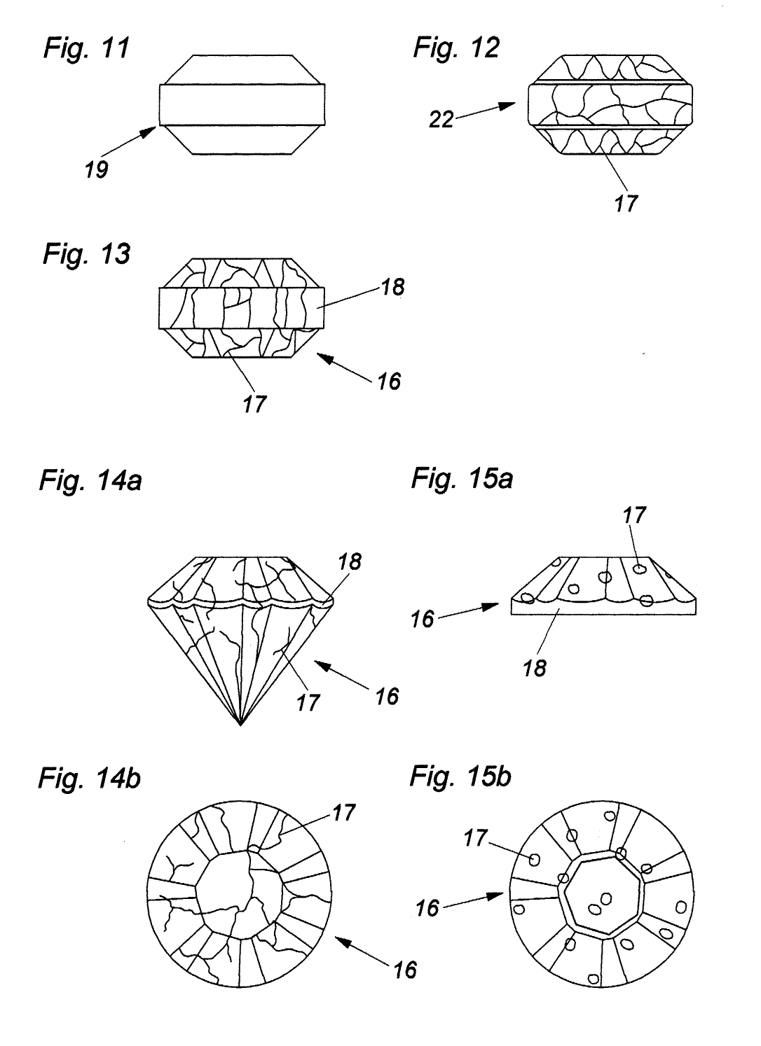

FIG. 11 shows a diagrammatic view of at least partially coated and pressed granular ceramic raw material,

FIG. 12 shows a diagrammatic view of at least partially coated, pressed and scoured granular ceramic raw material,

FIG. 13 shows a view of a two-colored shaped ceramic part according to the invention.

FIGS. 14a and 14b show a side view and a plan view respectively of an embodiment of a shaped ceramic part according to the invention,

FIGS. 15a and 15b show a side view and a plan view respectively of a further embodiment of a shaped ceramic part according to the invention,

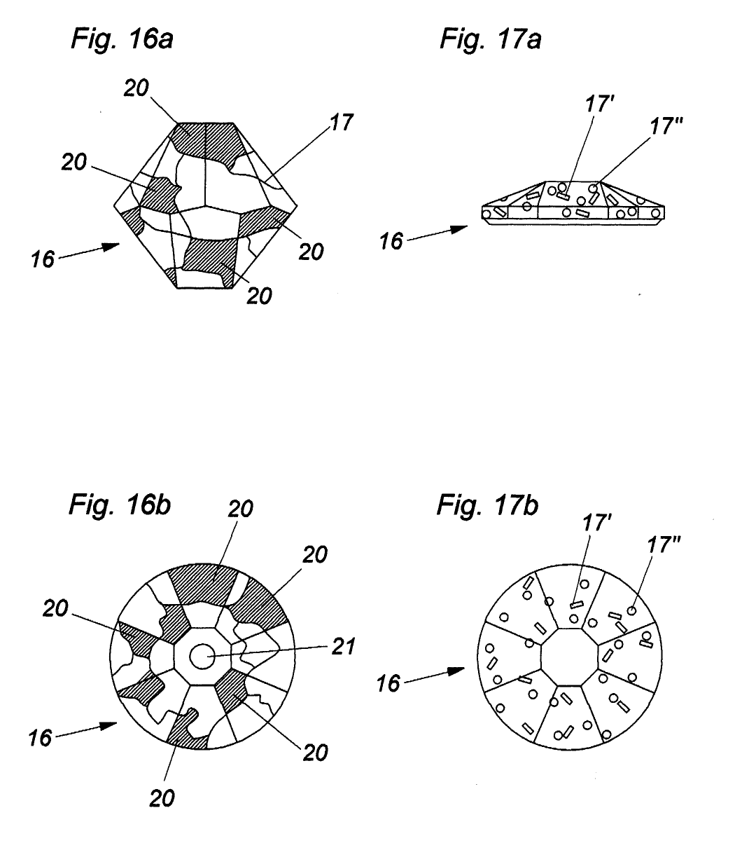

FIGS. 16a and 16b show a side view and a plan view respectively of a further embodiment of a shaped ceramic part according to the invention,

FIGS. 17a and 17b show a side view and a plan view respectively of a further embodiment of a shaped ceramic part according to the invention,

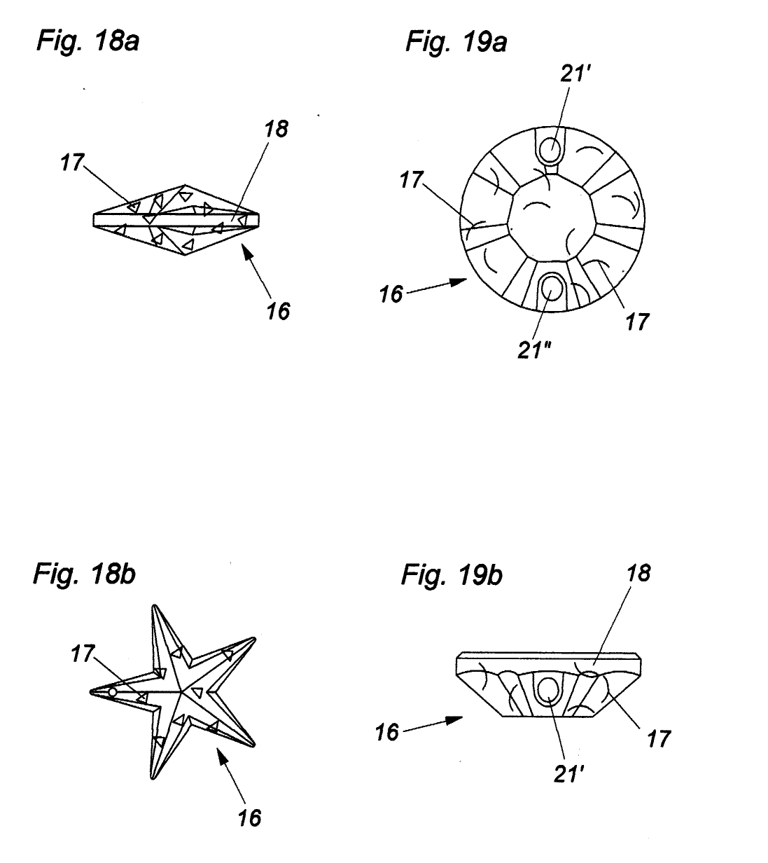

FIGS. 18a and 18b show a side view and a plan view respectively of a further embodiment of a shaped ceramic part according to the invention,

FIGS. 19a and 19b show a side view and a plan view respectively of a further embodiment of a shaped ceramic part according to the invention, and

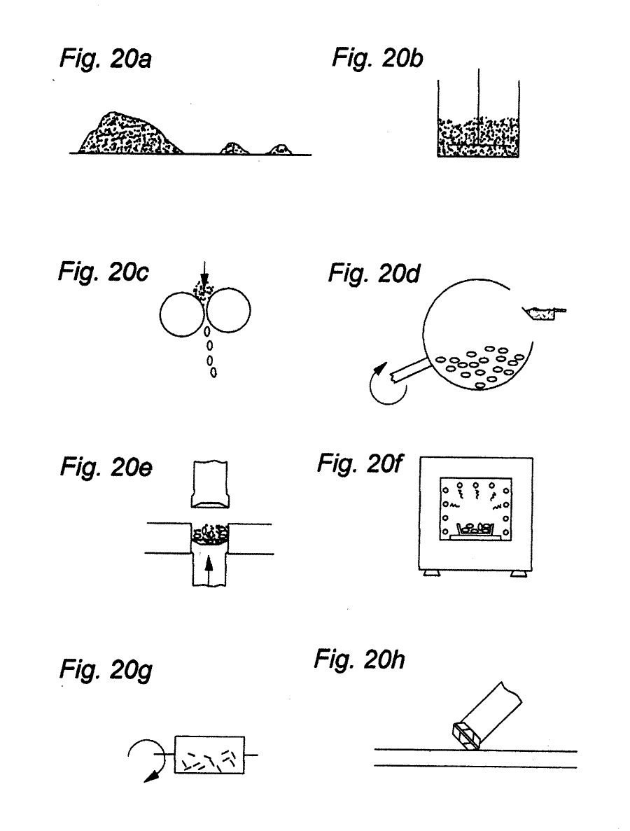

FIGS. 20a through 20h show a diagrammatic view of an operating procedure of the process according to the invention.

FIG. 1 diagrammatically shows the starting materials for the process according to the invention. Besides the ceramic raw material 1 which in that case can comprise a mixture of quartz, feldspar and stratified silicates, a colored pigment substance 2 is required, with which the surface of the granulated ceramic raw material is at least partially coated. It can also be provided that the ceramic raw material 1 is colored with a colored pigment 2′ or the granulated ceramic raw material 5 is at least partially coated with a further color.

FIG. 2 diagrammatically shows how the ceramic raw material 1 is thoroughly mixed in a mixing apparatus 3. In that respect it can be provided that the ceramic raw material 1 is colored with a colored pigment 2′ of a first color.

FIG. 3 shows a diagrammatic view of a granulation procedure, wherein the ceramic raw material 1 is pressed to afford a granular ceramic raw material 5 in a roller press 4 comprising two oppositely rotating rollers arranged at a small spacing relative to each other. Such granulation procedures are known per se in the state of the art and, besides that pressing operation which rather produces round granular materials, it is possible to use various other granulation procedures to produce a granular ceramic raw material 5 as is used in the process according to the invention.

FIG. 4 shows a diagrammatic view in which the colored pigment substance 2 is added with an apparatus 7 to the granular ceramic raw material 5 disposed in a rotating mixing mechanism 6. In this case the granular ceramic raw material 5 can have been previously sprayed with water or however the colored pigment substance 2 may also represent a fluid colored pigment-water suspension and the apparatus 7 can be in the form of a spray apparatus.

FIG. 5 diagrammatically shows a pressing operation, wherein the granular ceramic raw material 8 which is at least partially coated—as shown in FIG. 4—is pressed into a given shape in a pressing apparatus 9, the shape in this embodiment being represented by the two halves 10′, 10″ of a tool.

FIG. 6 diagrammatically shows how the at least partially coated and pressed granular ceramic raw material 11 is sintered in a sintering furnace 13. That sintering process can be effected for example for 30 minutes at about 1200° C. The sintering process provides that the porosity of the at least partially coated and pressed granular ceramic raw material 11 is reduced, which also involves a certain shrinkage process.

Due to the pressing operation it can happen that portions of the surface of the at least partially coated and pressed granular ceramic raw material are single-colored, which involves an unwanted decorative effect. To remove parts of that color which comprises the coating with the colored pigment substance 2 from the surface, an embodiment of the invention provides that a plurality of at least partially coated, pressed and sintered grains of the granular ceramic raw material 19 is moved in a rotating mixing drum 12. In that way the surface of the at least partially coated, pressed and sintered granular ceramic raw material 19 is scoured off, that surface having a certain roughness after that irregular scouring process. Such a scouring process can also take place prior to the sintering process instead of after it.

FIG. 8 diagrammatically shows a further embodiment of the invention. Here an at least partially coated, pressed, sintered and scoured granular ceramic raw material 22 is passed with a holder 14 against a grinding means 15, whereby at least parts of the surface are ground in a faceted configuration to produce a shaped ceramic part 16 according to the invention.

FIGS. 9 through 13 show the products which belong to many stages in the above-discussed procedure. FIG. 9 diagrammatically shows the granular ceramic raw material 5 as is produced after a granulation process as shown in FIG. 3. In this case the granular ceramic raw material is substantially angular. FIG. 10 shows how the colored pigment substance 2 is deposited on the granular ceramic raw material 5 and thus an at least partially coated granular ceramic raw material 8, as shown in FIG. 4, is produced. In that respect that coating can be regular or irregular, by the surface of the individual grains of the granular ceramic raw material 5 being only partially coated and additionally or alternatively individual grains of the granular ceramic raw material 5 not being coated at all.

FIG. 11 shows an at least partially coated, pressed and sintered granular ceramic raw material 19. Due to the pressing operation in this case the surface is at least in part of a single color as the coated granular ceramic raw material 5 has been arranged in such a way that the coating with colored pigment substance 2 is to be found over a large area at the outside of the pressed and sintered granular ceramic raw material 19.

FIG. 12 shows a shaped ceramic part 22 as is afforded by a scouring process as shown in FIG. 7 from the shaped ceramic part 19. It is possible to clearly see the band-like structure 17 representing the second of the at least two colors of the shaped ceramic part according to the invention. In this case the individual bands of the band-like structure 17 are formed by the coating and shaped by the boundary surface of a plurality of grains which are pressed together of the granular ceramic raw material 5. In this case the regions between the bands are of the color of the granular ceramic raw material 5.

FIG. 13 shows a shaped ceramic part 16 as is produced from a grinding process as illustrated in FIG. 8. In this case the top side and underside of the shaped ceramic part 16 are ground in faceted configuration, while a central part is left as an edge 18 which is left natural, as results from the scouring process. Once again it is possible to clearly see the band-like structure 17 with the second of the at least two colors of the shaped ceramic part 16 according to the invention.

FIG. 14a shows a side view of a further embodiment of a shaped ceramic part 16 according to the invention with band-like structure 17 and a narrow edge 18 which is left natural. A corresponding plan view is shown in FIG. 14b. Depending on the respective grinding process any shapes are possible for the shaped ceramic part 16 according to the invention.

FIG. 15a shows a side view of a further embodiment of a shaped ceramic part 16. In this case the underside and the top side are ground flat with facets and an edge 18 left natural therebetween. In this embodiment a round granular ceramic raw material 5 was used, whereby the band-like structure 17 is substantially circular. A corresponding plan view is shown in FIG. 15b. As the size of the granular ceramic raw material 5 in this embodiment is irregular the sizes of the circular band-like structure 17 are also irregular.

A further embodiment of a shaped ceramic part 16 is to be seen as a side view in FIG. 16a. Prior to the pressing operation, a further granular ceramic raw material of a different color was added to the coated granular ceramic raw material 8 which governs the band-like structure 17. After the grinding process which produces the faceted surface of the shaped ceramic part 16, parts of the surface corresponding to the further added granular ceramic raw material are then of a further color. In this case those regions are represented by the hatched surfaces 20. Accordingly it is possible to produce shaped ceramic parts 16 with more than two colors. The plan view in FIG. 16b shows a hole 21 which serves as a device for fixing to a chain or a thread. As the irregular band-like structure 17 shows the granular ceramic raw material 5 used in this embodiment is irregular in shape and size.

In the embodiment of the shaped ceramic part 16 shown in a side view in FIG. 17a the band-like structure 17 comprises regular rectangles 17′ and circles 17″. They are produced by the granular ceramic raw material 5 used, comprising regular cylinders and regular spheres of equal size, being coated and then ground after pressing and sintering. The coating of the cylindrical granular ceramic raw material 5 is then to be seen as a rectangular band 17′ and the coating of the spherical granular ceramic raw material 5 is to be seen as a circular band 17″.

A further embodiment of a shaped ceramic part 16 according to the invention is shown in FIGS. 18a and 18b. A stellate shaped ceramic part 16 was produced here in the grinding process. By virtue of the prismatic grains used in the granular ceramic raw material 5, the band-like structure 17 in this embodiment comprises triangles. The individual coated grains of the granular ceramic raw material 5 were in that case completely ensheathed with colored pigment substance 2, which can be seen at the triangles throughout of the band-like structure 17.

FIG. 19a shows a plan view of a further embodiment of a shaped ceramic part 16. The grains used here in the granular ceramic raw material 15 were only partially coated, as can be seen from the band-like structure 17 consisting of shorter lines. In addition, arranged in the shaped ceramic part 16 is a hole 21 serving as a device for fixing for example to a chain. It can however also be provided that two clips are mounted in the two openings 21′ and 21″.

The individual production steps for producing a shaped ceramic part 16 are summarised once again in the diagrammatic views of FIGS. 20a through 20h. No references are shown here by virtue of the compact representation of the individual process steps. It will be noted however that the individual views correspond to FIGS. 1 through 8 and are there shown on an enlarged scale with references.

It will be apparent that the process according to the invention is not limited to the specific embodiments nor is it to be restricted thereby.

1. A process for the production of at least two-colored shaped ceramic parts from a granular ceramic raw material having a first of the at least two colors, wherein the second of the at least two colors is added as a colored pigment or a colored pigment substance and the surface of the granular ceramic raw material is at least partially coated, wherein the coated granular ceramic raw material is then pressed into a solid form.

2. A process as set forth in claim 1 wherein the colored pigment substance is fluid or pulpy, wherein the granular ceramic raw material is coated with the colored pigment substance.

3. A process as set forth in claim 1 wherein the colored pigment substance is in powder form and has preferably less than 65% proportion of ceramic raw material.

4. A process as set forth in claim 1 wherein the surface of the granular ceramic raw material is at least partially coated by mixing of the granular ceramic raw material with the colored pigment or the colored pigment substance.

5. A process as set forth in claim 1 wherein the grain size of the granular ceramic raw material is less than 5 mm.

6. A process as set forth in claim 1 wherein the grain size of the granular ceramic raw material is less than 3 mm.

7. A process as set forth in claim 1 wherein the granular ceramic raw material is produced by pressing ceramic raw material into given shapes.

8. A process as set forth in claim 7 wherein said ceramic raw material is pressed into at least one shape selected from the group consisting of spherical shape and parallelepipedic shape.

9. A process as set forth in claim 2 wherein the granular ceramic raw material is produced by pressing ceramic raw material into given shapes.

10. A process as set forth in claim 1 wherein the granular ceramic raw material is produced by pressing ceramic raw material to provide shells and subsequently by at least one procedure selected from the group consisting of breaking the pressed shells and sieving off.

11. A process as set forth in claim 1 wherein the granular ceramic raw material is produced by mixing ceramic raw material and binding agent to an extent of between 5% and 25% and subsequently drying and comminuting it with at least one selected from the group consisting of mixing tools and blades.

12. A process as set forth in claim 11 wherein said binding agent is water.

13. A process as set forth in claim 1 wherein the granular ceramic raw material is produced by mixing ceramic raw material and binding agent to an extent of between 10% and 20% and subsequently drying and comminuting it with at least one selected from the group consisting of mixing tools and blades.

14. A process as set forth in claim 13 wherein said binding agent is water.

15. A process as set forth in claim 1 wherein the granular ceramic raw material is produced by mechanical movement of the ceramic raw material which is in the form of a dry powder and simultaneous spraying with fluid and then drying.

16. A process as set forth in claim 1 wherein the granular ceramic raw material is produced by mixing ceramic raw material and binding agent to an extent of between 5% and 25% and subsequent extrusion through a sieve and re-drying.

17. A process as set forth in claim 16 wherein said binding agent is water.

18. A process as set forth in claim 1 wherein the granular ceramic raw material is produced by mixing ceramic raw material and binding agent to an extent of between 15% and 20% and subsequent extrusion through a sieve and re-drying.

19. A process as set forth in claim 18 wherein said binding agent is water.

20. A process as set forth claim 1 wherein the granular ceramic raw material is produced by mixing ceramic raw material and binding agent to an extent of between 5% and 25% and subsequent extrusion and rounding of the fragments.

21. A process as set forth in claim 20 wherein the binding agent is water.

22. A process as set forth in claim 1 wherein the granular ceramic raw material is produced by mixing ceramic raw material and binding agent to an extent of between 15% and 20% and subsequent extrusion and rounding of the fragments.

23. A process as set forth in claim 22 wherein the binding agent is water.

24. A process as set forth in claim 1 wherein the minerals of the ceramic raw material which is in the form of a powder or fine initial granular material are crushed to grain sizes of less than 100 μm.

25. A process as set forth in claim 1 wherein the first of the at least two colors of the shaped ceramic part is added as a colored pigment substance or at least one selected from the group consisting of a natural pigment and a synthetic colored pigment to the ceramic raw material.

26. A process as set forth in claim 25 wherein said first of the at least two colors of the shaped ceramic part is added before it is granulated.

27. A process as set forth in claim 1 wherein the second of the at least two colors is added by spraying the granular ceramic raw material with a fluid colored pigment substance.

28. A process as set forth in claim 1 wherein at least partial coating of the surface of the granular ceramic raw material is performed at least twice, with differently colored pigments or colored pigment substances.

29. A process as set forth in claim 1 wherein at least partial coating of the surface of the granular ceramic raw material is performed at least twice, with identically colored pigments or colored pigment substances which are present in a differing concentration.

30. A process as set forth in claim 1 wherein prior to the actual pressing operation a part of the granular ceramic raw material is pressed into given shapes and sintered.

31. A process as set forth in claim 1 wherein the granular ceramic raw material is pressed with pressures of less than 500 bars.

32. A process as set forth in claim 1 wherein the granular ceramic raw material is pressed with pressures of between 100 and 300 bars.

33. A process as set forth in claim 1 wherein the granular ceramic raw material is pressed with pressures of more than 500 bars.

34. A process as set forth in claim 1 wherein prior to the operation of pressing the granular ceramic raw material a further granular ceramic raw material is added, at least partially coated.

35. A process as set forth in claim 34 wherein said further granular ceramic raw material is at least partially coated with a further differently colored pigment or a further differently colored pigment substance.

36. A process as set forth in claim 1 wherein a device for fixing to a carrier is arranged on the pressed granular ceramic raw material.

37. A process as set forth in claim 1 wherein the pressed granular ceramic raw material is sintered.

38. A process as set forth in claim 1 wherein the pressed granular ceramic raw material is scoured.

39. A process as set forth in claim 37 wherein the pressed granular ceramic raw material is sintered at a temperature of between 500° C. and 1300° C. for about 30 minutes.

40. A process as set forth in claim 37 wherein the pressed granular ceramic raw material is sintered at a temperature of about 1200° C. for about 30 minutes.

41. A process as set forth in claim 1 wherein the pressed and sintered granular ceramic raw material is at least portion-wise processed by at least one of the operations selected from the group consisting of cutting, grinding, cleaving and polishing.

42. An at least two-color shaped ceramic part produced by a process as set forth in claim 1.

43. A piece of jewellery produced from an at least two-colored shaped ceramic part produced by a process as set forth in claim 1.
